(19) United States
(12) Patent Application Publication
(10) Pub. No.: US 2018/0374058 A1
(43) Pub. Date: Dec. 27, 2018

(54) Systems and Methods for Use in Facilitating Transfers Associated With Electronic Messages

(71) Applicant: MASTERCARD INTERNATIONAL INCORPORATED, Purchase, NY (US)

(72) Inventor: Anthony Perrone, St. Louis, MO (US)

(21) Appl. No.: 15/631,304

(22) Filed: Jun. 23, 2017

(51) Int. Cl. G06Q 10/10; H04L 12/58; G06F 15/16; G06Q 20/10; G06K 9/54; G06Q 20/04; G06Q 30/02

(52) U.S. Cl. CPC G06Q 10/1097; H04L 51/12; G06F 15/16; G06Q 30/0219; G06K 9/54; G06Q 20/0425; G06Q 20/102

(57) ABSTRACT

Systems and methods are provided for use in facilitating transfers associated with electronic messages. One exemplary method includes, in response to a send request, searching an electronic message from a sender person to a recipient person for at least one trigger term suggestive of a transfer, prompting the sender person to utilize a service when the at least one trigger term is identified, and invoking the service in response to an input accepting the service from the sender person, whereby the service is accessed via a message service associated with the message. The exemplary method further includes sending the message to the recipient person when at least one trigger term is not identified in the message or in response to an input declining the service.

### FIELD

The present disclosure generally relates to systems and methods for use in facilitating transfers associated with electronic messages, and in particular, to systems and methods for use in prompting persons, based on identifying trigger terms in electronic messages (e.g., in emails, etc.) being sent by the persons, to use the one or more peer-to-peer (P2P) transfer services.

### BACKGROUND

This section provides background information related to the present disclosure which is not necessarily prior art.

People often have accounts of different varieties to hold funds, and also to transfer funds to and from as desired. Such accounts include, for example, payment accounts (e.g., credit accounts, checking accounts, etc.), savings accounts, and other accounts. For a checking account, for example, a person may transfer funds from his/her checking account to a recipient, by writing and sending a paper check, which is then later deposited by the recipient into his/her account (where after the funds are transferred). Alternatively, a person may create a payment transaction to the recipient's account through one or more different peer-to-peer (P2P) services. The PayPal™ payment service is one known service for sending funds from a sender to a recipient, based on an email address or phone number associated with the recipient, whereupon the recipient has to supply account information for the transfer to be completed. Other similar payment services such as, for example, Venmo™, Google Wallet™, Square Cash™, Dwolla™, etc., are also known.

Separately, people are known to send electronic messages, such as, for example, emails, short-message service (SMS) messages, and/or social network messages to other people as a manner of communication with the other people about a variety of subjects, from business to personal.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating fund transfers between accounts via one or more peer-to-peer (P2P) payment services;

FIG. 2 is a block diagram of a computing device that may be used in the exemplary system of FIG. 1;

FIG. 3 is an exemplary method that may be implemented in the system of FIG. 1 for use in facilitating fund transfers between accounts via one or more P2P payment services;

FIG. 4 is an exemplary message interface including a message composed by a sender person, for use in the method of FIG. 3; and

FIG. 5 is the exemplary message interface of FIG. 4, further including a prompt for the sender person to use a payment service in accordance with the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

People often transfer funds between accounts for a variety of reasons, be it between their own accounts or be it from their accounts to those of other recipients. Separately, people may, from time to time, send electronic messages (e.g., emails, short-message-service (SMS) messages, social network messages, etc.) to the recipients of the fund transfers to forecast the impending transfer and/or to otherwise provide details about the funds to be transferred (or the funds that have already been transferred). Uniquely, the systems and methods herein permit message services to identify messages (prior to the messages being sent) in which persons sending the messages either intend or forecast fund transfers, and to prompt the persons to utilize particular payment services to actually transfer the funds in connection with the message. In particular herein, when a sender person selects to send a message to a recipient person, the message service searches the message for an integrated payment and/or for one or more terms indicative of a desire, intention, and/or need to transfer funds to the recipient person. Upon identifying such a payment and/or one or more “trigger” terms, the message service prompts the sender person to utilize a payment service associated with the message service (e.g., a peer-to-peer (P2P) service, etc.) to send the funds. In this manner, the message is used to identify the potential fund transfer, and then to offer the payment service as a mechanism to actually facilitate that fund transfer. As such, the sender person, through a simple electronic message, is able to avoid a separate, distinct interaction with a payment service, while the payment service is permitted to target the sender person (and other sender persons) who is/are expected to need such services. Accordingly, the systems and methods herein provide a sequence of events associated with fund transfers that override routine and conventional sequences of fund transfers, thereby providing improvement in existing technologies through increased convenience and flexibility and/or through unique interactions aimed to yield more efficient and convenient fund transfers.

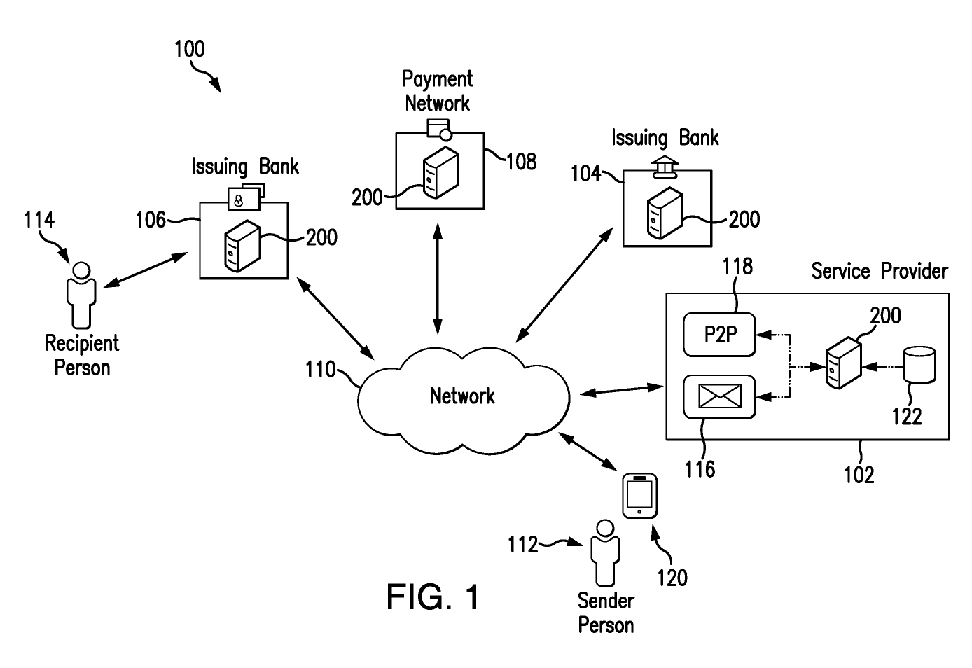

FIG. 1 illustrates an exemplary system 100 in which the one or more aspects of the present disclosure may be implemented. Although the system 100 is presented in one arrangement, other embodiments may include systems arranged otherwise depending, for example, on manners in which P2P transactions are processed, types and/or integration of P2P services in the systems, and/or accounts involved in the transactions, etc.

In the illustrated embodiment, the system 100 generally includes a service provider 102, a first issuing bank 104, a second issuing bank 106, and a payment network 108, each coupled to and/or in communication with network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private network made accessible by the payment network 108 to the issuing banks 104, 106 and, separately, the public Internet, which is accessible as desired to the service provider 102 and one or more various persons in the system 100 (e.g., persons 112, 114, etc.), etc.

As shown, the service provider 102 includes an electronic message service 116 and a P2P payment service 118. While the service provider 102 includes both the message service 116 and the payment service 118 in this exemplary embodiment, the services 116, 118 may be separate and provided through different service providers in other embodiments. For example, the message service 116 may be provided by a search engine service provider (e.g., Google®, etc.), while the payment service 118 may be provided by one of the issuing banks 104, 106 and/or the payment network 108. Similarly, while two services 116, 118 are illustrated as associated with only one computing device 200 (described below), in other embodiments the services 116, 118 may be included in different computing devices and/or multiple different computing devices located together and/or distributed across a geographic region.

In this exemplary embodiment, the message service 116 is configured to provide message services to one or more persons. The message service 116 may include, without limitation, email, SMS messages, and other types of messages in which a person, such as, for example, sender person 112, authors a message and sends it to another person, such as recipient person 114. Examples of message services may include, without limitation, GMAIL®, YAHOO®, and Outlook® message services, etc., which may include both network-based services hosted locally or remotely, etc. Other example message services may include message services associated with communication devices (e.g., as provided by Verizon®, AT&T®, etc.; as associated with SMS and/or telecom services; etc.), and/or WhatsApp® or other similar message applications, etc. In addition, in various embodiments, the message service 116 may include one or more social network services, such as, for example, Twitter®, Facebook®, Yelp®, and/or Pinterest® social network services, etc. With that said, in general, the message service 116 may include any suitable service whereby a person is able to send an electronic message to another person or entity.

As indicated above, the payment service 118 includes a P2P payment service, in which a person is permitted to transfer funds from one account to another account (e.g., from his/her account to an account associated with another person and/or entity, etc.). For example, in this exemplary embodiment, the payment service 118 is provided to enable funds to be transferred from an account, issued by the first issuing bank 104 to the sender person 112, to another account, issued by the second issuing bank 106 to the recipient person 114. And again, while the P2P payment service 118 is shown in the illustrated embodiment, in FIG. 1, as included in the service provider 102 (e.g., such that the message service 116 and the P2P payment service 118 are integrated via an application programming interface (API), whereby the message service 116 and the P2P payment service 118 are commonly hosted by the service provider 102 and are able to communicate via an API; etc.), it should be appreciated that in other embodiments the P2P payment service 118 may be incorporated, in whole or in part, in either of the issuing banks 104, 106 and/or the payment network 108 in other embodiments (e.g., apart from the message service 116 at the service provider 102, etc.). Furthermore, when the P2P payment service 118 is not integrated with the message service 116, or is not hosted by a common entity (e.g., the service provider 102, etc.), the payment service 118 is often, but not always, still associated with the message service 116 through one or more business associations. In such later embodiments, the P2P payment service 118 (wherever integrated) may request (and receive) permission from the service provider 102 (and/or the message service 116 and/or the sender person 112), for example, during installation of an application associated therewith to a communication device 120 associated with the sender person 112, etc., to access messages generated by the sender person 112 via the message service 116 (e.g., to read, scan, etc. the messages for trigger words as described herein; etc.).

In one example fund transfer transaction, the sender person 112 interacts with the payment service 118 to transfer funds to the account of the recipient person 114. In doing so, the sender person 112 supplies, to the payment service 118, an email address (or phone number) associated with the recipient person 114, and requests a transfer of $50, for example, from his/her account (as issued by the issuing bank 104) to the account of the recipient person 114 (as issued by the issuing bank 106). In turn, the payment service 118 communicates with the issuing bank 104 and receives the fund transfer transaction therefrom (as associated with the account of the sender person 112) (whereby the issuing bank 104 secures funding from the sender person 112 (and specifically from his/her account) for the transaction), and then communicates the transaction (and, potentially, a confirmation of available funds) to the payment network 108 (such as, for example, to the network operated by MasterCard International Incorporated, the assignee of the present disclosure). In turn, the payment network 108 (via application of appropriate business controls) routes the fund transfer transaction to the issuing bank 106 (associated with the account of the receiving person 114). Upon receipt, the issuing bank 106 posts the transfer of $50 to the account of the recipient person 114. The fund transfer transaction is then later cleared/settled between the issuing bank 104 and the issuing bank 106.

As further shown in FIG. 1, the sender person 112 is associated with the communication device 120. The communication device 120 is configured to permit the sender person 112 to utilize one or both of the message service 116 and the payment service 118 (e.g., initiate the fund transfer described above, etc.) For example, the communication device 120 may include a network-based browser (e.g., Chrome® browser, Internet Explorer® browser, Safari® browser, etc.), or other network-based application(s) installed thereon, suitable to interact with one or more of the services 116, 118 described herein.

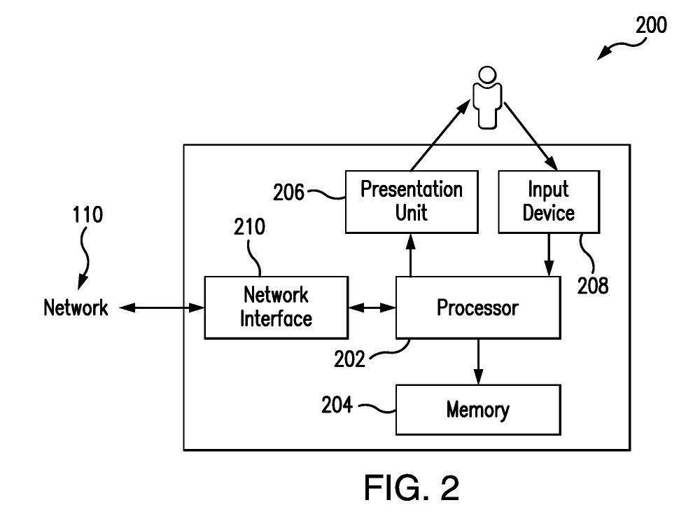

FIG. 2 illustrates an exemplary computing device 200 that can be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, each of the service provider 102, the issuing banks 104, 106, and the payment network 108 are illustrated as including, or being implemented in, computing device 200, coupled to the network 110. In addition, the communication device 120 associated with the sender person 112 may also be considered a computing device consistent with computing device 200. That said, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, data structures, trigger terms, electronic messages, and/or other types of data (and/or data structures) suitable for use as described herein. Furthermore, in various embodiments, executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In addition in the exemplary embodiment, the computing device 200 includes a presentation unit 206 that is coupled to (and that is in communication with) the processor 202 (however, it should be appreciated that the computing device 200 could include output devices other than the presentation unit 206, etc.). The presentation unit 206 outputs information (e.g., prompts to use a payment service, etc.), either visually or audibly, to a user of the computing device 200, for example, to facilitate the use of one or more payment services by the sender person 112, etc. And, various interfaces (e.g., as defined by SMS messages, emails, social network messages, prompts to use payment services, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, entries to compose a message, an accept or decline prompt for a payment service, etc. The input device 208 is coupled to (and is in communication with) the processor 202 and may include, for example, a keyboard, a pointing device, a mouse, a stylus, a touch sensitive panel (e.g., a touch pad or a touch screen, etc.), a product scanner, another computing device, and/or an audio input device. Further, in various exemplary embodiments, a touch screen, such as that included in a tablet, a smartphone, or similar device (e.g., the communication device 120, etc.), behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks, including the network 110. Further, in some exemplary embodiments, the computing device 200 may include the processor 202 and one or more network interfaces (including the network interface 210) incorporated into or with the processor 202.

Referring again to FIG. 1, the system 100 also includes a data structure 122 associated with the service provider 102 (and more particularly, with the message service 116 of the service provider 102) comprising at least one trigger term profile for use in identifying potential fund transfer transactions, as described herein. In particular, each trigger term profile in the data structure 122 includes a number of trigger terms and/or phrases indicative of a desire, a need, and/or an intent of a person to transfer funds to another person (e.g., via the P2P payment service 118 or via another payment service, etc.). The data structure 122 may be included with the message service 116 in the computing device 200, as shown in FIG. 1 (and as indicated by the dotted lines). However, in other embodiments, the data structure 122 may be stored apart from the message service 116 in one or more other computing devices.

Table 1 illustrates various exemplary trigger terms/phrases that may be included in an exemplary trigger term profile, stored in the data structure 122. As shown, each trigger term is also associated with a count (e.g., 34, 35, 71, 12, etc.), which generally indicates a number of times the given term/phrase has successfully been associated with a transaction message. As described more below, for each message evaluated by the message service 116, the trigger term profile is updated and, in so doing, the count associated with one or more of the trigger terms/phrases included in the trigger term profile may be adjusted (e.g., increased, decreased, etc.). In connection therewith, the various terms in the trigger term profile are included therein based on their corresponding counts satisfying a predefined threshold (e.g., 0, etc.). Then, when a count for a trigger term in the trigger term profile fails to satisfy the threshold (e.g., after being adjusted, etc.), the trigger term may be removed from the trigger term profile.

TABLE 1

| | | | | | |
|---|---|---|---|---|---|
| Check is in | Mailing you a | Sending a | Sending the | Transfer the | Wire the |
| the mail (35) | check (78) | payment (28) | payment (43) | funds (34) | money (18) |
| Check is on | Money is on | Sending cash | Sending you a | Transfer the | Wire the |
| the way (22) | the way (55) | (32) | check (49) | money (62) | payment (15) |
| Check will be | Money will be | Sending | Sending you a | Transfer your | Wire your |
| mailed (4) | sent (58) | funds (23) | payment (30) | cash (43) | cash (21) |
| Fund transfer | Payment is in | Sending | Sending you | Transfer your | Wire your |
| (68) | the mail (44) | money (44) | the cash (32) | funds (40) | funds (13) |
| Funds are in | Payment is on | Sending | Sending you | Transfer your | Wire your |
| the mail (22) | the way (34) | payment (45) | the funds (20) | money (34) | payment (19) |
| Funds are on | Payment will | Sending | Sending you | Western | |
| the way (19) | be made (43) | some cash | the money (71) | Union (12) | |
| | | (21) | | | |
| Funds will be | Payment will | Sending the | Sending you | Wire the cash | |
| sent (28) | be sent (23) | funds (5) | the payment | (19) | |
| | | | (11) | | |
| Mailing a | Sending a | Sending the | Transfer the | Wire the | |
| check (79) | check (29) | money (55) | cash (26) | funds (21) | |

It should be appreciated that the trigger terms/phrases included in Table 1 (e.g., in the exemplary trigger term profile stored in the data structure 122, etc.) are provided for illustrative purposes only, and should not be considered limiting as to possible trigger terms/phrases that may be included in other trigger term profiles. As such, in other embodiments, trigger term profiles may include one or more of the same terms/phrases included in Table 1, or they may include different variations thereof or different terms/phrases all together. It should also be appreciated that trigger terms/phrases may be included in trigger term profiles in one or more different languages (e.g., in English and Spanish, etc.).

In general in the system 100, the message service 116 is configured, upon receipt of a selection to send a message compiled by the sender person 112 at the communication device 120, for example, to determine if the message includes a payment (e.g., to determine if a payment is integrated to the message (e.g., to determine if the message defines a payment, etc.), such as a GMAIL® message invoking a payment through Google Wallet™ or a Facebook message having a debit card payment associated therewith; etc.), and if not, to then search in the message for one or more of the trigger terms included in the trigger term profile in the data structure 122. When it is determined that the message does not involve a payment and when one or more trigger terms are identified in the message, the message service 116 is configured to then prompt the sender person 112 to utilize the payment service 118 in order to include and/or incorporate the desired fund transfer into the message being sent. The sender person 112 can then accept or decline the prompt. In turn, when the sender person 112 accepts the prompt to include/incorporate (or integrate) the fund transfer into the message, the message service 116 is configured to invoke the payment service 118 (e.g., via an API, etc.), and then to send (or transmit) the message when the payment service 118 has been used to actually transfer the funds (e.g., when the payment is integrated to the message using the payment service 118 as described above, when the payment is performed via the payment service 118, etc.). In connection therewith, for example (and as generally described above), the payment service 118 may be configured to capture payment account details (e.g., credentials, etc.) from the sender person 112 and then communicate with the issuing bank 104 associated with the sender person 112 to send the appropriate funds to the issuing bank 106 associated with the recipient person 114. Alternatively, when the sender person 112 declines the prompt to include/incorporate the fund transfer into the message, the message service 116 is configured to simply send (or transmit) the message. In some embodiments, the communication device 120 may be configured (alone, or in combination with the message service 116) to invoke the payment service 118 (e.g., via an API, etc.) when the sender person 112 desires to include/incorporate (or integrate) the fund transfer into the message, and then to send (or transmit) the message when the payment service 118 has been used to actually transfer the funds (e.g., when the payment is integrated to the message using the payment service 118 as described above, when the payment is performed via the payment service 118, etc.).

In addition, the message service 116, based on whether a payment and/or trigger term is involved/included in the message, and/or whether the prompt to use the payment service 118 is accepted or declined, is configured to update the trigger term profile included in the data structure 122 based thereon. In particular, the message service 116 is configured to increase/decrease counts of trigger terms in the profile, to append new trigger terms and/or to remove existing trigger terms from the profile, as appropriate, etc., thereby updating the trigger term profile. For example, the message service 116 may be configured to increase a count for each trigger term in the trigger term profile in the data structure 122 that is also included in a message being sent by the sender person 112 identified as involving a fund transfer (and where the sender person 112 accepts the prompt to use the payment service 118 to transfer funds). Or, the message service 116 may be configured to decrease a count for each trigger term in the trigger term profile that is also included in a message being sent by the sender person 112 identified as involving a fund transfer (and where the sender person 112 declines the prompt to use the payment service 118 to transfer funds). As another example, the message service 116 may be configured to add new trigger terms to the trigger term profile in the data structure 122 when the message being sent by the sender person 112 includes terms identifying the message as involving a fund transfer (but not already included in the trigger term profile), and the sender person 112 accepts the prompt to use the payment service 118 to transfer funds. As a further example, the message service 116 may be configured to remove existing trigger terms from the trigger term profile in the data structure 122 (based on a threshold or otherwise) when the message being sent by the sender person 112 is identified through the existing trigger terms as involving a fund transfer but the sender person 112 declines the prompt to use the payment service 118.

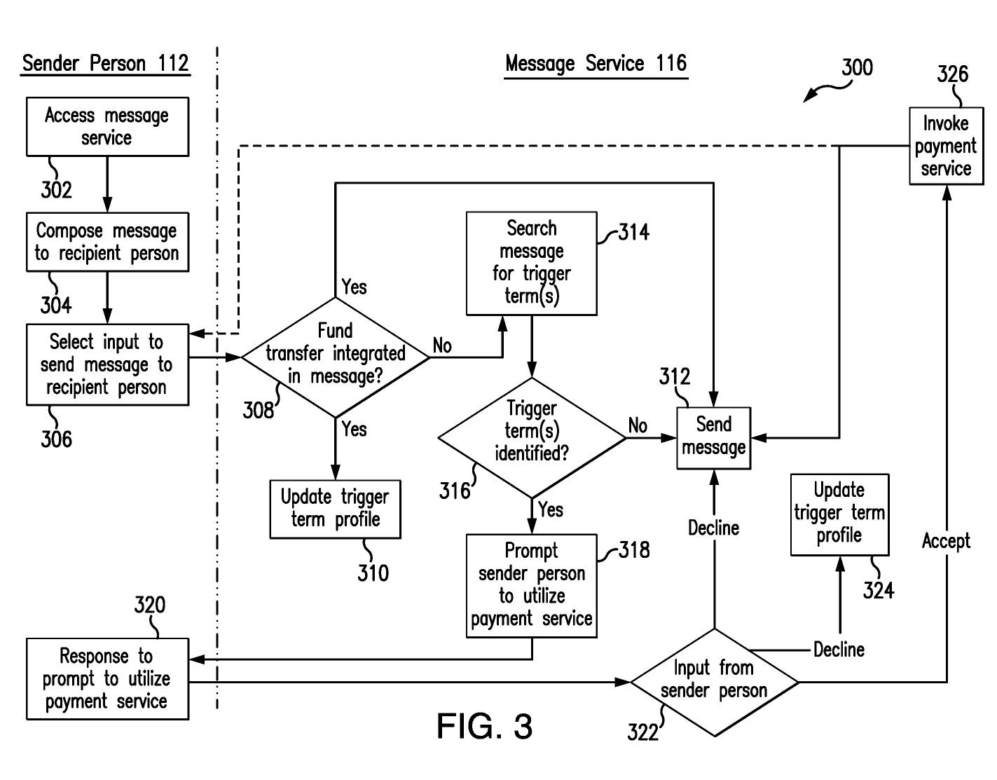

FIG. 3 illustrates an exemplary method 300 for use in facilitating fund transfers between accounts via one or more P2P payment services. The exemplary method 300 is described with reference to the system 100, and specifically, the sender person 112, the recipient person 114, the message service 116, and the payment service 118, and also with reference to the computing device 200. However, it should be understood that the method 300 is not limited to the system 100 or the computing device 200, as other systems and computing devices may be employed to perform the methods described herein. And, likewise, the systems and the computing devices herein should not be understood to be limited to the exemplary method 300.

Initially in the method 300, when the sender person 112 desires to transfer funds to the recipient person 114, the sender person 112 accesses the message service 116, at 302, for example, via his/her communication device 120, etc., and composes a message forecasting the fund transfer to the recipient person 114, at 304. Then, after composing the message, the sender person 112 selects an input (e.g., via input device 208, etc.), at 306, at the communication device 120, to send the message to the recipient person 114.

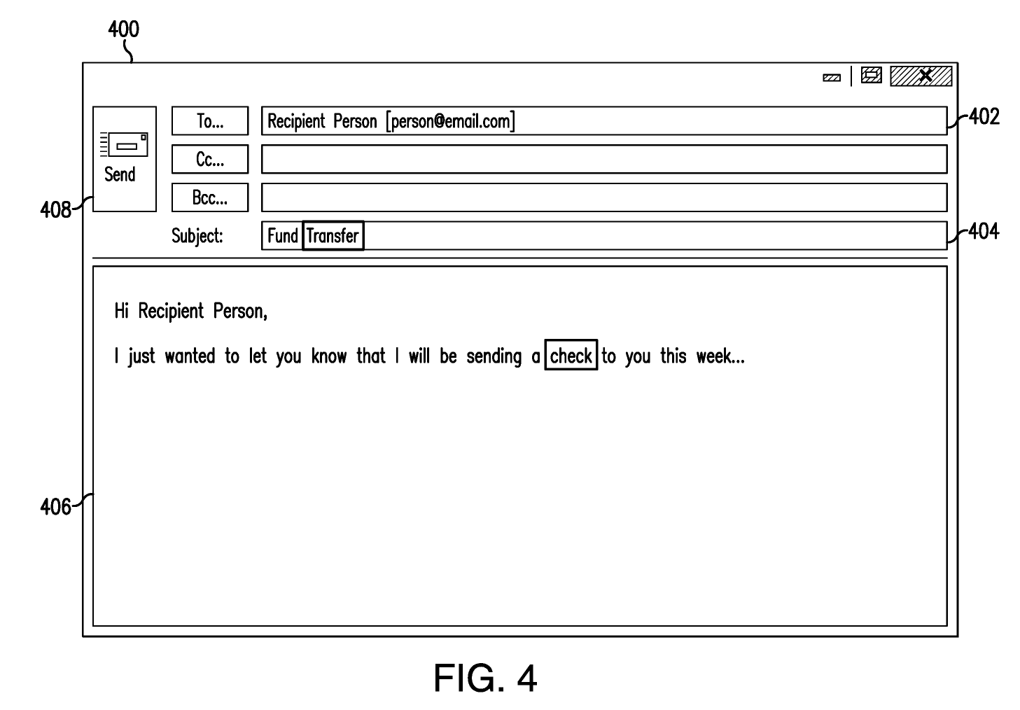

FIG. 4 illustrates an exemplary message interface 400 that may be displayed at the communication device 120 to the sender person 112 upon accessing the message service 116. The sender person 112 can then use the interface 400 to generate the message for sending to the recipient person 114. As shown, the message interface includes a “To:” section 402 indicating the intended recipient of the message (i.e., Recipient Person at person@email.com), a subject line 404 into which the person is able to include a subject of the message (i.e., Fund Transfer), and a message body field 406 into which the sender person 112 is able to compose or otherwise input a message for the recipient person 114. Once the message is composed, the sender person 112 then selects a “Send” button 408 to direct the message to the recipient person 114. It should be appreciated that the electronic message format may be different in interfaces in other embodiments, particularly when the electronic message is other than an email. It should further be appreciated that the display of the message, via the message service 116, and the user's interaction with the message interface 400, are generally understood by those skilled in the art.

Referring back to FIG. 3, in response (and prior to actually transmitting the message to the recipient person 114), the message service 116 determines, at 308, whether a fund transfer payment is integrated to the message. This may include the message service 116 determining whether the sender person 112, in connection with composing the message, also invoked an API (e.g., via the message service 116, etc.) to perform a fund transfer in connection with composing the message (and, potentially in connection therewith, determining whether the sender person entered account information and/or a fund transfer amount via the API). For example, for a message sent via GMAIL®, this may include the message service 116 determining whether the message is associated with (or invokes) Google Wallet™ and a payment associated therewith (e.g., determining if a particular input was provided by the sender person 112 when composing the message (e.g., selection of a “$” icon during composition of the message, etc.)). Alternatively, for a message sent via Facebook Messenger, this may include the message service 116 determining whether the message is associated with (or invokes) a debit card and a payment associated therewith (e.g., determining if a particular input was provided by the sender person 112 when composing the message (e.g., selection of a “$” icon during composition of the message, etc.)). Further, in some embodiments, determining, at 308, whether a fund transfer payment is integrated to the message may also include identifying a particular payment service (or alternative payment service to the one already integrated, for example, payment service 118, etc.) to be used for the fund transfer (e.g., taking into account the trigger terms in the message, actions taken by the sender person 112 in generating the message, etc.).

When such a fund transfer payment is integrated to the message, the message service 116 updates, at 310, the trigger term profile in the data structure 122, based on the message and, in particular, on the terms/phrases included in the message. In addition, at 312, the message service 116 sends (or transmits) the message to the recipient person 114. In connection with updating the trigger term profile at 310, the message service 116 may increment, by 1 (in the trigger term profile), for example, a count for each of the trigger terms in the trigger term profile that are also present in the body and/or the subject of the given message. However, it should be appreciated that the message service 116 may use the message (and its content) to update/modify the trigger term profile in other ways as well (e.g., other than increasing term counts, etc.), when a fund transfer payment is integrated to the message. For example, the message service 116 (or another part of the system 100) may add terms included in the given message to the listing of terms in the trigger term profile (when such terms are not already present in the profile).

In facilitating such updates to the trigger term profile (or even in originally generating the trigger term profile), it should be appreciated that the message service 116 (or other part of the system 100) may ignore generally neutral terms in the message such as “the,” “a,” “some,” “is,” etc. and not add or include such terms in the trigger term profile (e.g., terms (or terms from messages) that have scores of 0.5 or less when evaluated using a naïve Bayes classifier and/or the Graham's algorithm, etc.). What's more, in some embodiments, only the terms (e.g., the top ten terms, the top fifteen terms, etc.) in a message having the greatest absolute values may be considered (e.g., again when evaluated using a naïve Bayes classifier and/or the Graham's algorithm, etc.) (e.g., where the absolute values are calculated for each term as the absolute value of: 0.5−term score; etc.), and added to or included in the trigger term profile.

In addition to the above, the message service 116 (or another part of the system 100) may also (or alternatively) implement machine learning protocols to evaluate content of messages previously associated with fund transfers and determine which terms included in the messages are indicative of the fund transfers, etc., such that future messages may then be evaluated to predict whether or not they are indicative of fund transfers. For example, a naïve Bayes classifier and/or a Graham scan (or Graham's algorithm) may be used alone, or in combination, to perform such predictions.

In connection therewith, the trigger terms/phrases included in Table 1 (as part of the exemplary trigger term profile), for example, may be used as a starting point for the naïve Bayes classifier and/or the Graham scan (or other algorithm), whereby a message is evaluated (e.g., scanned, etc.) for such terms/phrases (as generally described herein) and, when found, the message service 116 then prompts the sender person 112 (associated with the message) to utilize the payment service 118 for the potential fund transfer payment (as will be described in more detail hereinafter). Additionally, or alternatively, the message service 116 (or another part of the system 100) may initially evaluate prior messages (e.g., at least 10 prior messages, at least 100 prior messages, at least 1,000 prior messages, at least 10,000 prior messages, etc.) known to be payment related and prior messages (e.g., at least 10 prior messages, at least 100 prior messages, at least 1,000 prior messages, at least 10,000 prior messages, etc.) known not to be payment related, and identify/retrieve terms/phrases therefrom that are most often found in payment messages and not often found in nonpayment messages in order to populate the trigger term profile (and the terms included in Table 1, for example, if not already done). The trigger terms/phrases included in the trigger term profile may then be used, as described above, as the starting point for the naïve Bayes classifier and/or the Graham scan (or other algorithm). What's more, the results from the naïve Bayes classifier and/or the Graham scan (or other algorithm) may also be used, as desired, to update/modify the trigger term profile (e.g., the terms shown in Table 1, etc.) as described above, etc. (and thereby impact what words are, or are not, associated with payment-related messages in connection with subsequent applications of the naïve Bayes classifier and/or the Graham scan (or other algorithm)). In this manner, the trigger term profile is generally a living feature of the present disclosure, whereby the results of the naïve Bayes classifier and/or the Graham scan (or other algorithm) allow terms/phrases to be removed from the profile, added to the profile, provided additional weight, etc. And in so doing, the counts associated with each of the terms/phrases may also change (see, Table 1). Further, when the message is identified as a payment-related message and the sender person 112 declines to utilize the payment service 118 for the potential fund transfer payment, the various trigger terms/phrases identified in the message may be removed from the trigger term profile or the count associated therewith may be decreased (and/or it may be less likely for such terms/phrases to be included in the trigger term profile). Conversely, when the message is identified as a payment-related message and the sender person 112 agrees to utilize the payment service 118 for the potential fund transfer payment, the various trigger terms/phrases identified in the message may be provided additional weight in the trigger term profile (e.g., the count associated therewith may be increased by a greater amount, etc.) (and/or it may be more likely for such terms/phrases to be included in the trigger term profile).

As an example, for an email message, M, the naïve Bayes classifier may be used to estimate the likelihood, L(p|M), that the message could be payment related and the likelihood, L(r|M)=1−L(a|M), that the message is not payment related (see, Equation 1). Based on these probabilities, the classifier may then be used to predict one of the two outcomes (or classes), p or r. Typically, the classifier identifies (or picks) the outcome with the larger estimated probability, i.e., the classifier predicts p if L(p|M)>L(r|M) and r otherwise. More generally in the naïve Bayes classifier, a decision threshold, d, may be defined and then used to predict class p if the probability L(p|M) is at least d times the probability L(p|M), and otherwise class r.

$$\tilde{c} ( M ) = \{ \begin{matrix}p if \frac{L ( p \vert M )}{L ( r \vert M )} > d \\ r if \frac{L ( p \vert M )}{L ( r \vert M )} \leq d\end{matrix} \qquad ( 1 )$$

In addition, for estimating the probability P(a|M), the naïve Bayes classifier may use Bayes' law (see, Equation 2). In connection therewith, L(p) is the likelihood for the message to be a payment related message, i.e., the probability that any message is payment related without considering the actual text of the message; L(M) is the likelihood for the message to actually contain text, i.e., the probability that text of a given message can be observed independent of whether the message is payment related or not; and L(M|p) is the likelihood that text of a given message would occur in the class p of messages that are payment related.

$$L ( p \vert M ) = \frac{L ( M \vert p ) L ( p )}{L ( M )} \qquad ( 2 )$$

In the above description, L(p) can be estimated from available message data, for example, identifying the percentage of messages that contain a payment (e.g., from data in the trigger term profile, etc.) (see, Equation 3), etc. In addition, L(r) can be estimated analogously (again, see, Equation 3). And, L(M) can be considered as a normalizing constant, based on Equation 4.

$$\begin{matrix} \text{?} & ( 3 ) \\ L ( M ) = L ( M \vert p ) * L ( p ) + L ( M \vert r ) * L ( r ) & ( 4 ) \\ \text{?} \text{indicates text missing or illegible when filed} & \end{matrix}$$

Further in this example, word extraction may be used to divide the message into single words, t. In connection therewith, and as generally provided by Equation 5, an assumption may be made that the occurrence of a particular word in the message may depend on the class of the message (i.e., is the message payment related or not), but not on the presence of other words in the message. In Equation 5, L(t|p) is the probability that the particular word occurs in the message. L(M|r), then, is computed analogously. And, the values L(t|p) and L(t|r) are then estimated as described above. In turn, these variables may then be combined via Equation 6 to yield an estimate or score, nb(M), for the terms in the message (and the message) and the likelihood, L(p|M), that the message should be payment related (e.g., have a payment prompt, etc.) (e.g., on a scale of 0 to 1, etc.).

$$\begin{matrix}L ( M \vert p ) = {Π}_{t ∈ M} L ( t \vert p ) & ( 5 ) \\ nb ( M ) = \frac{L ( p ) * {Σ}_{t ∈ M} L ( t \vert p )}{L ( p ) * {Σ}_{t ∈ M} L ( t \vert p ) + L ( r ) * {Σ}_{t ∈ M} L ( r \vert p )} \approx L ( p \vert M ) & ( 6 )\end{matrix}$$

As another example, for an email message, Graham's algorithm may be used to determine whether, or not, the message is a payment-related message. In so doing, Graham's algorithm makes use of two heuristic weights, w_{t,p} and w_{t,r}, assigned to each word (or term), t, in the message, one for the payment-related class, p, and one for the class, r, of regular messages (see, Equation 7).

$${w}_{t , p} = min ( 1 , {c}_{p} * \frac{{n}_{t , P}}{\vert {D}_{p} \vert} ) {w}_{t , r} = min ( 1 , {c}_{r} * \frac{{n}_{T , R}}{\vert {D}_{r} \vert} ) \qquad ( 7 )$$

For both of the heuristic weights in this example, a proportion may be determined between the numbers of words in the payment-related message set, P, and the regular message set, R, and the numbers of messages in the respective classes, p and r. In connection therewith, both weights are set cₚ=cᵣ=1, and the two weights are then combined into an overall weight, wₜ (see, Equation 8), indicating how often a particular word, t, occurs in the message, with respect to a message that is not payment related. The higher the value (or wₜ), the larger the probability that the word is an indicator for the payment-related class, p.

$${w}_{t} = max ( A , min ( Z , \frac{{w}_{t , p}}{{w}_{t , p} + {w}_{t , r}} ) ) \qquad ( 8 )$$

In the above, the values A and Z are user specific (e.g., the values are set by a user, etc.), where the value A specifies the lowest value that a word can have (i.e., if the word is in the regular message class) and the value Z specifies the highest value that a word can have (i.e., if the word is in the payment-related message class). Because, in general, 0<A<1 and 0<Z<1 and A<Z, the value of wₜ is generally between 0 and 1.

Further in this example, and with reference to Equations 9 and 10, when all minima and maxima in these equations are ignored and an assumption is made that the number of payment related messages is approximately equal to the number of regular messages, then wₜ may essentially estimate the likelihood that a given word occurs in a payment related message of class p than in a regular message of class r. In connection therewith, for a given message, M, Graham's algorithm may then be used to select the 15 words, tᵢ, for example, whose weights, w are most different from 0.5. The words may then be combined into a score, g(M), for the message. And, in order to determine if the message is payment related (e.g., should have a payment prompt, etc.), the score, g(M), is compared with a threshold score, g (see, Equation 11).

$$\begin{matrix}L ( p \vert t ) = \frac{{n}_{t , A}}{{n}_{t , A} + {n}_{t , R}} \approx \frac{\frac{{n}_{t , A}}{\vert {D}_{p} \vert}}{\frac{{n}_{t , A}}{\vert {D}_{p} \vert} + \frac{{n}_{t , R}}{\vert {D}_{r} \vert}} & ( 9 ) \\ g ( M ) = \frac{{Π}_{i = 1}^{15} {w}_{i}}{{Π}_{i = 1}^{15} {w}_{i} + {Π}_{i = 1}^{15} ( 1 - {w}_{i} )} & ( 10 ) \\ \tilde{c} ( M ) = \{ \begin{matrix}p if g ( M ) > g \\ r if g ( M ) \leq g\end{matrix} & ( 11 )\end{matrix}$$

As still another example, the respective scores from the naïve Bayes classifier (see, Equation 6) and Graham's algorithm (see, Equation 10) may be combined (e.g., based on preliminary test scenarios, updating with time, etc.). In so doing, both algorithms are initially evaluated independently (as described in the above examples), and their respective scores, nb(M) and g(M), are computed. As described, both scores are in the range [0, 1]. The scores may then be combined, for example, via a weighted average such as shown in Equation 12, where s(M) is the combined score for the message and v is a factor that indicates the relative importance of the two different algorithms. The combined score may then be compared to predefined threshold scores, s, to predict whether the message is payment related (i.e., is in class r) or not (i.e., is in class r) (see, Equation 13). In other words in this example, for a defined threshold score of 0.5 (i.e., for s=0.5), when a message ultimately has a combined score of 0.4 (i.e., for s(M)=0.4), the message would be considered a regular message (or non-payment related message). Alternatively, for a message having a combined score of 0.6 (i.e., for s(M)=0.6), the message would be considered a payment related message.

$$\begin{matrix}s ( M ) = \frac{v * nb ( M ) + g ( M )}{v = 1} & ( 12 ) \\ \tilde{c} ( M ) = \{ \begin{matrix}p if s ( M ) > s \\ r if s ( M ) \leq s\end{matrix} & ( 13 )\end{matrix}$$

Further, in various embodiments, the message service 116 (or another part of the system 100) may implement pattern detection and/or recognition to determine whether certain payments (or fund transfers) are occurring on a frequent basis, such as, for example, paying a dog walker daily, paying a baby sitter weekly or bi-weekly, etc. This may be done, for example, as a check to determine if a payment recipient has previously been paid by a sender, etc. (and, if so, how many times, how long ago, etc.). In connection therewith, the message service 116 and/or the payment service 118 may further provide the sender person 112 with an option to automate the fund transfer in the future (whereupon the message service 116 and/or the payment service 118 may solicit additional details about the fund transfers (e.g., interval, recurring date, amount, etc.).

Alternatively in the method 300, when the message service 116 determines, at 308, that a fund transfer payment is not integrated to the message, the message service 116 searches in the subject and/or body of the message, at 314, for one or more trigger term(s) from the trigger term profile in the data structure 122. If the message service 116 determines, at 316, that no such trigger terms are included in the message, the message service 116 proceeds to send the message, at 312. However, when the message service 116 determines, at 316, that the message includes at least one trigger term from the trigger term profile in the data structure 122, the message service 116 prompts, at 318, the sender person 112 to utilize the payment service 118 for the potential fund transfer payment. With that said, it should be appreciated that in other embodiments, at 316, the message service 116 may require multiple trigger terms such that the message is determined to include at least a threshold number of trigger terms from the trigger term profile (e.g., at least two trigger terms, at least three trigger terms, etc.). In these embodiments, if the message service 116 determines that the message does not include the threshold number of trigger terms, the message service 116 then proceeds to send the message, at 312 (without prompting the sender person 112 to utilize the payment service 118).

In turn, the sender person 112 responds to the prompt to utilize the payment service 118, or not, at 320. When the sender person 112 declines the prompt, as determined by the message service 116, at 322, the message service 116 proceeds to send the message, at 312 (e.g., transmit the message after the seconder person responds to the prompt interface, etc.). The message service 116 also updates the trigger term profile, at 324, in a similar manner to that described above (e.g., as done at 310 in the method 300, etc.). In particular, for example, the message service 116 may decrease (e.g., by 1, etc.), in the trigger term profile, the count for each of the trigger terms in the trigger term profile that are also included in the body and/or subject of the given message. That is, because the trigger terms present in the message cause the sender person 112 to be prompted to use the payment service 118, and because the sender person 112 did not utilize the payment service 118, the trigger terms may not be good, or suitable, indicators of a desired intention or need of sender persons in general to transfer funds, to recipient persons. As such, they are accorded less weight in the trigger term profile. Additionally, or alternatively, the trigger terms may be subjected to additional machine learning protocols, pattern detection and/or recognition, etc. in adjusting the trigger term profile included in the data structure 122.

Conversely, when the sender person 112 accepts the prompt to utilize the payment service 118, as determined by the message service 116, at 322, the message service 116 invokes the payment service 118, at 326 (alone, or in conjunction with the communication device 120), thereby permitting the sender person 112 to incorporate, or integrate, the fund transfer payment into the message (e.g., as described above, etc.). The interactions between the relevant entities in connection with the fund transfer payments are then consistent with those described above with reference to FIG. 1. For example, the message service 116 may invoke the payment service 118 through credentials of the sender person 112, via XML payload, which in turn calls a web service (URL) to process the request as appropriate (e.g., forward the fund transfer transaction to the appropriate entities for funding, etc.). Regardless, once the payment service 118 is invoked, and the fund transfer payment is completed (e.g., the fund transfer payment is integrated to the message, etc.) (or, more generally, after the seconder person responds to the prompt interface (e.g., the prompt interface 500 below, etc.)), the message service 116 proceeds to send the message, at 312. Alternatively, as indicated by the dotted lines in FIG. 3, the sender person 112 may be returned to the message, and permitted to select another input to send the message, at 306. In this later alternative, once the message is exposed to the method 300, the message service 116 will either recognize, at 308, that a fund transfer is integrated to the message, or simply not again perform subsequent operations of the method 300 on the message (such that when the sender person 112 again selects to send the message, at 306, the message service 116 proceeds to directly send the message, at 312).

In connection therewith, the funding of the transfer may generally be verified and secured by the issuing bank 104 upon the sender person 112 invoking the payment service 118 (in connection with sending the message). Then, when the message is actually sent and the recipient person 114 opens the message, and accepts the fund transfer (e.g., by an affirmative input, by taking no action, etc.), the actual transaction flow may complete the “purchase” of the funding amount and send the funds to the recipient person's account.

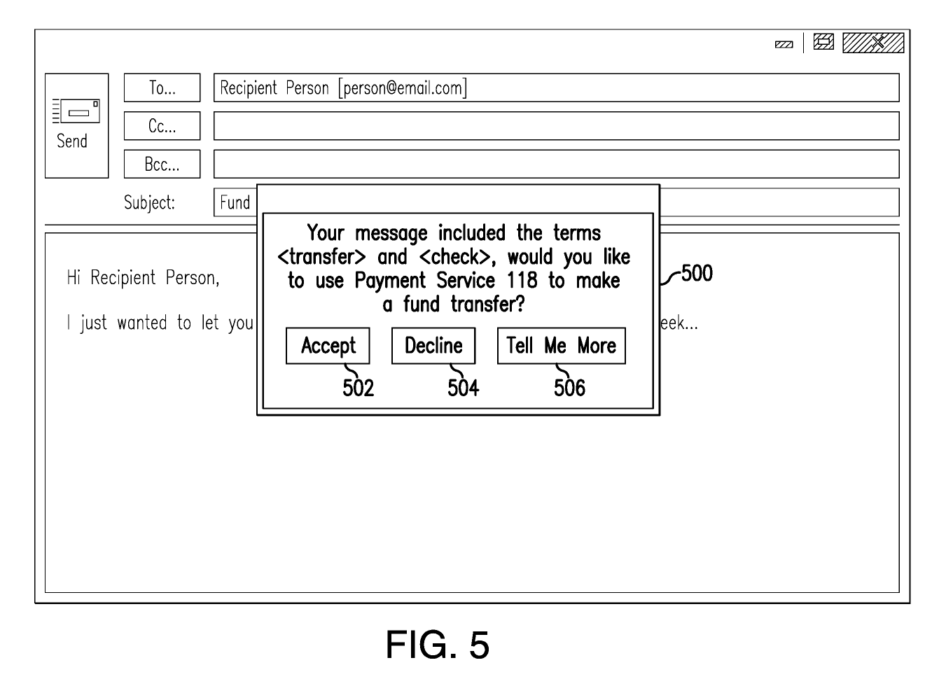

As an example of the above, and with reference again to the exemplary message interface 400 in FIG. 4, in evaluating the message (after the sending person 112 provides the appropriate input to send the message (e.g., at 306 in the method 300, etc.)), the message service 116 may determine (e.g., at 316 in the method 300, etc.) that the subject line 404 includes the trigger term “transfer” and that the message body field 406 includes the trigger term “check” (as indicated by the reference boxes around these terms in FIG. 4). In response, and with additional reference to FIG. 5, the message service may cause a prompt interface 500 to be displayed to the sender person 112, overlaid on the message interface 400. The prompt interface 500 indicates to the sender person 112 that certain trigger terms were included in the message (i.e., “transfer” and “check”), and invites the sender person 112 to utilize the payment service 118 to transfer funds. As shown, the prompt interface includes a button 502 to accept the prompt to use the payment service 118 to make the fund transfer payment, a button 504 to decline the prompt, and a button 506 to request more information about using the payment service 118 to make the fund transfer payment.

In view of the above, the systems and methods herein provide for prompting a sender person to include a fund transfer in an electronic message when the content of the electronic message suggests that the fund transfer is desired, intended, and/or needed. As such, the mere sending (or attempt to send) of an electronic message, which contains one or more trigger terms, is permitted to provide a unique interaction, whereby the sender person is provided with the option to interact with the payment service prior to sending the electronic message. In doing so, efficiencies are gained by integration of the payment service into the electronic message, such that additional interactions (as is conventional or routine) may be avoided. The above therefore provides increased flexibility and/or efficiency in a manner dependent on technology to yield improved interactions between sender persons and payment services.

It should also be appreciated that the systems and methods herein may be used for identifying messages other than payment-related messages (broadly, investigate for message content other than payment-related message content) and, in connection therewith, for prompting senders of the messages (broadly, for making suggestions) for other services (other than fund transfer services) based on the content of the messages. For example, the systems and methods may be used to identify ride or transport related messages that suggest the senders are in need of transportation (e.g., based on terms such as “I need a ride,” etc.). In turn, upon identification of such messages, the systems and methods may prompt the senders to download a transportation application (e.g., UBER, etc.). Or, the systems and methods may be used to identify food related messages that suggest the senders are hungry or looking for meal options (e.g., based on terms such as “Let's have pizza for dinner,” etc.). In turn, upon identification of such messages, the systems and methods may prompt the senders to order from particular restaurants, taking into account the particular content of the messages (e.g., a pizza restaurant when an identified term includes “pizza,” etc.).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) in response to a send request, searching an electronic message from a sender person to a recipient person for at least one trigger term suggestive of a fund transfer, (b) prompting the sender person to utilize a payment service when the at least one trigger terms is identified, (c) invoking the payment service in response to an input accepting the payment service from the sender person, whereby the payment service is accessed via a message service associated with the message, and (d) sending the message to the recipient person when at least one trigger terms is not identified in the message or in response to an input declining the payment service.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include, without limitation, a good, a service, a donation, a utility, etc.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating transfers through a service, the method comprising:
in response to a send request for an electronic message being sent from a sender person to a recipient person, searching, by a computing device, the electronic message for at least one trigger term suggestive of a transfer, prior to sending the electronic message;
prompting, by the computing device, the sender person to utilize a payment service when the at least one trigger term is identified;
invoking, by the computing device, the payment service in response to an input accepting the prompt for the payment service from the sender person, whereby the payment service is accessed via a message service associated with the electronic message to facilitate the transfer; and
sending the electronic message to the recipient person when at least one trigger term is not identified in the electronic message or in response to an input declining the payment service.

2. The computer-implemented method of claim 1, wherein the transfer includes a fund transfer payment; and
wherein the payment service is a peer-to-peer payment service integrated with the message service.

3. The computer-implemented method of claim 1, wherein the computing device comprises a trigger term profile including the at least one trigger term; and
wherein the at least one trigger term includes multiple trigger terms.

4. The computer-implemented method of claim 3, further comprising adjusting the trigger term profile in response to an input declining the payment service.

5. The computer-implemented method of claim 3, further comprising determining whether the electronic message defines a transfer prior to searching the electronic message for at least one trigger term; and
sending the electronic message, without searching for at least one trigger term, when the electronic message includes the transfer.

6. The computer-implemented method of claim 5, further comprising adjusting the trigger term profile when the electronic message defines the transfer and/or the electronic message includes the at least one trigger term.

7. The computer-implemented method of claim 6, wherein adjusting the trigger term profile includes incrementing a count associated with at least one of the multiple trigger terms when the at least one of the multiple trigger terms is included in the electronic message.

8. The computer-implemented method of claim 1, wherein the at least one trigger term includes at least a threshold number of trigger terms; and
wherein prompting the sender person to utilize the payment service when the at least one trigger term is identified includes prompting the sender person to utilize the payment service only when the at least a threshold number of trigger terms are identified in the electronic message.

9. The computer-implemented method of claim 1, wherein the electronic message includes a short-message-service (SMS) message.

10. A system for use in facilitating payments through a payment service, the method comprising:
a memory comprising a trigger term profile having multiple trigger terms suggestive of a fund transfer payment; and
a processor in communication with the memory and configured to:
search an electronic message, from a sender person to a recipient person, for one or more of the trigger terms included in the memory;
cause a prompt interface to display at a computing device associated with the sender person when one or more of the trigger terms are identified in the electronic message, the prompt interface including an invite to utilize a payment service to perform a fund transfer payment;
invoke the payment service in response to an input by the sender person accepting the invite to utilize the payment service, whereby the payment service is accessed by a message service associated with the electronic message via an application programming interface; and
transmit the electronic message to the recipient person after the sender person responds to the prompt interface.

11. The system of claim 10, wherein each of the multiple trigger terms in the trigger term profile is associated with a count; and
wherein, in response to the input by the sender person accepting the payment service, the processor is further configured to increase the count, in the trigger term profile, of each of the multiple trigger terms identified in the electronic message.

12. The system of claim 10, wherein each of the multiple trigger terms in the trigger term profile is associated with a count; and
wherein, in response to an input by the sender person declining the payment service, the processor is further configured to decrease the count, in the trigger term profile, of each of the multiple trigger terms identified in the electronic message.

13. The system of claim 12, wherein the processor is further configured to:
determine whether the electronic message defines a payment prior to searching the electronic message for one or more of the trigger terms included in the memory; and
when the electronic message defines said payment, transmit the electronic message to the recipient person without searching the electronic message for one or more of the trigger terms included in the memory.

14. The system of claim 13, wherein the processor is further configured, when the electronic message defines said payment, to increase the count, in the trigger term profile, of each of the multiple trigger terms identified in the electronic message.

15. The system of claim 14, wherein the trigger term profile further includes a count threshold; and
wherein the processor is further configured to remove one of the multiple trigger terms from the trigger term profile when the count for said one of the multiple trigger terms fails to satisfy the count threshold.

16. The system of claim 15, wherein the payment service is a peer-to-peer payment service integrated with the message service; and
wherein the electronic message includes one of an email and a short-message-service (SMS) message.

17. The system of claim 16, further comprising the payment service, the payment service configured to:
communicate with an issuing bank associated with the sender person to generate the fund transfer payment: and
transmit the fund transfer payment to a payment network, whereby the payment network is able to then transmit the fund transfer payment to an issuing bank associated with the recipient person to thereby effect the fund transfer payment from the sending person to the recipient person.

18. A non-transitory computer-readable storage media including computer-executable instructions for facilitating payments through a payment service, which, when executed by a processor, cause the processor to:
receive a send request for an electronic message generated by a sender person and directed to a recipient person;
search in a subject and/or a body of the electronic message for at least one trigger term, from a trigger term profile, suggestive of a fund transfer payment by the sender person to the recipient person;
when the at least one trigger term is identified in the subject and/or the body of the electronic message, prompt the sender person to utilize a payment service to effect a fund transfer payment to the recipient person; and
in response to an input by the sender person accepting the prompt for the payment service, invoke the payment service and adjust the trigger term profile based on the input; and
transmit the electronic message to the recipient person after the fund transfer payment is initiated via the payment service.

19. The non-transitory computer-readable storage media of claim 18, wherein the executable instructions, when executed by the processor, further cause the processor to, in response to an input by the sender person declining the payment service, transmit the electronic message to the recipient person and adjust the trigger term profile based on the decline.

20. The non-transitory computer-readable storage media of claim 18, wherein the executable instructions, when executed by the processor, further cause the processor to:
determine whether the electronic message defines a payment prior to searching the subject and/or the body of the electronic message for at least one trigger term; and
when the electronic message defines said payment, transmit the electronic message to the recipient person without searching the subject and/or the body of the electronic message for at least one trigger term.
